(19) United States
(12) Patent Application Publication
(10) Pub. No.: US 2019/0140240 A1
(43) Pub. Date: May 9, 2019

(54) SEPARATOR, METHOD OF MANUFACTURING THE SAME, AND NON-AQUEOUS ELECTROLYTE SECONDARY BATTERY INCLUDING THE SEPARATOR

(71) Applicant: Samsung Electronics Co., Ltd., Suwon-si (KR)

(72) Inventors: Ryo IWAMURO, Kanagawa (JP); Hironari TAKASE, Kanagawa (JP); Yoshitaka YAMAGUCHI, Kanagawa (JP); Mitsuharu KIMURA, Kanagawa (JP)

(21) Appl. No.: 16/184,739

(22) Filed: Nov. 8, 2018

(30) Foreign Application Priority Data
Nov. 8, 2017 (JP) 2017-215723
Feb. 2, 2018 (KR) 10-2018-0013433

(51) Int. Cl. H01M 2/16

(52) U.S. Cl. CPC H01M 2/1666; H01M 2/1686; H01M 2/1633; H01M 2/1626; H01M 2/1653

(57) ABSTRACT

Provided herein is a separator for a non-aqueous electrolyte secondary battery, the separator having a stacked structure including: a first layer including a polyolefin-based resin, the first layer being a porous film; a second layer including the polyolefin-based resin and a water-based polymer; and a third layer including a binder consisting of the polymer and cellulose nanofibers, and a method of making the same.

### CROSS-REFERENCE TO RELATED APPLICATIONS

This application claims the benefit of Japanese Patent Application No. 2017-215723, filed on Nov. 8, 2017, in the Japanese Patent Office, and Korean Patent Application No. 10-2018-0013433, filed on Feb. 2, 2018, in the Korean Intellectual Property Office, the entire disclosures of which are hereby incorporated herein by reference.

### BACKGROUND

### 1. Field

The present disclosure relates to separators, methods of manufacturing the same, and non-aqueous electrolyte secondary batteries including the separators.

### 2. Description of the Related Art

Secondary batteries are widely used in mobile electronic devices, electric vehicles, and hybrid vehicles. Particularly, lithium-ion secondary batteries have been actively developed due to their high energy density.

Currently, as separators for a lithium-ion secondary battery, polyolefin-based microporous films, which are inexpensive, chemically stable, and have excellent mechanical characteristics, are mainly used. Recently, lithium-ion secondary batteries have been used in automobile applications. In this application, heat resistance at a temperature of 200° C. or higher is required for separators, but polyolefin-based resins alone cannot meet this requirement. To compensate for this, a method of applying ceramic particles to a polyolefin-based microporous film, a method using chemical crosslinking, or the like have been examined. However, while these methods increase the heat resistance temperature, it is difficult to secure excellent heat resistance at a temperature of 200° C. or higher and problems such as thermal contraction occur. Therefore, there remains a need for new separators for lithium-ion batteries.

### SUMMARY

Provided are separators with excellent heat resistance and excellent mechanical strength characteristics, and methods of manufacturing the same.

Also provided are non-aqueous electrolyte secondary batteries including the above-described separators.

According to an aspect of an embodiment, a separator includes: a first layer including a polyolefin-based resin, the first layer being a porous film; a second layer including a polyolefin-based resin and a water-based polymer; and a third layer including a water-based polymer and cellulose nanofibers.

In the cellulose nanofibers, the proportion of fibers having a diameter of less than 1 μm is about 80 wt % or more. In addition, the thickness of the third layer is about 1/10 or more than that of the first layer, and the thickness of the second layer is about ½ or less than that of the first layer. In addition, the total thickness of the separator ranges from about 5 μm to about 50 μm.

The polyolefin-based resin is at least one of a polyethylene-based resin and a polypropylene-based resin. In addition, the amount of the water-based polymer in the third layer ranges from about 0.1 parts by weight to about 40 parts by weight per 100 parts by weight of the cellulose nanofibers.

The separator may have an air permeability of about 50 seconds/100 cc to about 2,000 seconds/100 cc.

The amount of the cellulose nanofibers in the third layer ranges from about 60 parts by weight to about 99.9 parts by weight with respect to 100 parts by weight (total) of the water-based polymer and the cellulose nanofibers. In addition, the amount of the water-based polymer in the second layer ranges from about 60 parts by weight to about 99.9 parts by weight with respect to 100 parts by weight (total) of the water-based polymer and the polyolefin-based resin.

According to an aspect of another embodiment, a non-aqueous electrolyte secondary battery includes a positive electrode, a negative electrode, and the above-described separator positioned between said positive electrode and said negative electrode.

According to an aspect of another embodiment, a method of manufacturing a separator includes: preparing a porous film including a polyolefin-based resin; supplying a composition to the porous film including a polyolefin-based resin, the composition including cellulose nanofibers, a water-based polymer, a water-soluble organic solvent, and water; and drying the resulting product.

Additional aspects will be set forth in part in the description which follows and, in part, will be apparent from the description, or may be learned by practice of the presented exemplary embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view illustrating a cross-section of a separator according to an embodiment;

FIG. 2 is a microscopic image showing a cross-section of a separator according to an embodiment;

FIG. 3 is an enlarged microscopic image of region A of FIG. 2;

FIG. 4 is a microscopic image showing measurement points of Nano-infrared ray (Nano-IR) spectra;

FIG. 5 illustrates Nano-IR spectra; and

FIG. 6 is a schematic view of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a separator according to an embodiment, a method of manufacturing the same, and a non-aqueous electrolyte secondary battery including the separator will be described in more detail. The following description is provided only for illustrative purposes, and is not intended to limit applications or uses of these embodiments.

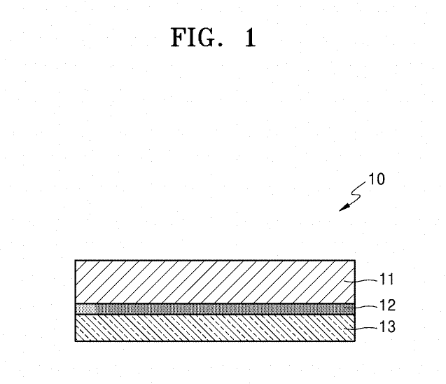

Referring to FIG. 1, a separator 10 according to an embodiment has a structure in which a second layer 12, which includes a water-based polymer as a binder and a polyolefin-based resin, and a third layer 13, which includes cellulose nanofibers, are stacked on a porous film 11 including a polyolefin-based resin. As used herein, the term “water-based polymer” refers to a water-soluble or water-dispersible polymer.

### Embodiment 1

<Porous Film Including Polyolefin-Based Resin>

Examples of the polyolefin-based resin include homopolymers or copolymers obtained by polymerizing a-olefin such as ethylene, propylene, 1-butene, 4-methyl-1-pentene, 1-hexene, or the like. In addition, a mixture of two or more of these homopolymers or copolymers may be used. Among these, at least one of a polyethylene-based resin and a polypropylene-based resin may be used.

Examples of the polyethylene-based resin include, but are not limited to, low density polyethylene, linear low density polyethylene, linear ultralow density polyethylene, medium density polyethylene, high density polyethylene, and copolymers including ethylene as a main component. The copolymers including ethylene as a main component may be copolymers or multi-copolymers of ethylene and at least one comonomer selected from C₃-C₁₀ α-olefins such as propylene, 1-butene, 1-pentene, 1-hexene, 1-heptene, 1-octene, and the like; vinyl esters such as vinyl acetate, vinyl propionate, and the like; unsaturated carboxylic acid esters such as methyl acrylate, ethyl acrylate, methyl methacrylate, ethyl methacrylate, and the like; and unsaturated compounds such as conjugated dienes, non-conjugated dienes, and the like, or mixed compositions of these copolymers. The content of ethylene units in the copolymer including ethylene as a main component is 50 wt % or higher.

The polyethylene-based resin may be at least one selected from low density polyethylene, linear low density polyethylene, and high density polyethylene.

The polypropylene-based resin may be homo-propylene (propylene homopolymer); a random copolymer or block copolymer of propylene, ethylene, and an a-olefin such as 1-butene, 1-pentene, 1-hexene, 1-heptene, 1-octene, 1-nonene, 1-decene, or the like; or the like. Among these, homo-polypropylene is suitable in terms of maintaining mechanical strength, heat resistance, and other aspects of the porous film.

As the polypropylene-based resin, for example, commercially available products such as NOVATEC™ PP and WINTEC™ (manufactured by Japan Polypropylene Corporation); NOTIO™ and TAFMER™ XR (manufactured by Mitsui Chemical Corporation); ZELAS™ and THERMOLAN™ (manufactured by Mitsubishi Chemical Corporation); SUMITOMO™ NOBLEN™ and TAFTHELEN™ (manufactured by Sumitomo Chemical Co., Ltd.); PRIME™ polypropylene and PRIME™ TPO (manufactured by Prime Polymer Co., Ltd.); ADFLEX™ , ADSYL™ , and HMS-PP(PF814) (manufactured by Sanaroma Corporation); and VERSIFY™ and INSPIRE™ (manufactured by Dow Chemical Company); and the like may be used.

In the separator according to an embodiment, an additive generally added to a resin composition may be appropriately added to the porous film including a polyolefin-based resin within a range that does not hinder the effect of the separator in addition to the above-described resins.

The porous film including a polyolefin-based resin may have a single-layered structure or a multi-layered structure, but is not particularly limited.

<Cellulose Nanofibers>

Cellulose nanofibers are wood-derived material that are thermally stable up to about 300° C., and thus have attracted attention as a separator material. However, in the case of a separator using cellulose fibers, numerous hydrogen bonds are generated between fibers due to hydroxy groups present on surfaces of the cellulose fibers, and thus the separator becomes hard and is easily broken. In particular, there are problems such as poor handling in a dry atmosphere or a lack of characteristics.

In other aspects, the disclosure provides a separator having excellent heat resistance, shutdown characteristics, and ease of handling; a method of manufacturing the same, and a non-aqueous electrolyte secondary battery including the separator.

The separator comprises cellulose nanofibers. The type of cellulose used as a raw material of cellulose nanofibers is not particularly limited, and may be, for example, natural cellulose obtained from biosynthesis of a plant, an animal, a bacteria-producing gel, or the like, that is separated and purified. More particularly, non-limiting examples of the cellulose include coniferous wood pulp, deciduous wood pulp, cotton-based pulp such as cotton linter, non-wood-based pulp such as wheat straw pulp and bagasse pulp, cellulose separated from bacteria or Ascidiacea, and cellulose separated from seaweed.

The cellulose nanofibers may have an average diameter ranging from about 3 nm to about 300 nm, for example, about 5 nm to about 200 nm, for example, 10 nm to 100 nm, for example, about 20 nm to 150 nm, for example, about 30 nm to 100 nm, for example, about 40 nm to about 80 nm. When the average diameter of the cellulose nanofibers is within the above range, air permeability of the separator is excellent. In addition, the inclusion fibers having a diameter of 1 μm or more should be minimized. In some embodiments, the proportion of fibers having a diameter of less than 1 μm is about 80 wt % or more, for example, about 95 wt %, and for example, ranges from about 95 wt % to 99 wt %. In some embodiments, the proportion of fibers having a diameter of 500 nm or less is about 80 wt % or more, and for example, ranges from about 80 wt % to about 99 wt %. By reducing the proportion of fibers having a large diameter, it is easy to control the thickness, micropore diameter, air permeability, and other aspects of the separator when forming a film.

The diameter of fibers may be measured by observing the state of the separator or a film formed by casting and drying a dilute solution of cellulose fibers, using a transmission electron microscope or a scanning electron microscope. By collectively evaluating the viscosity of a cellulose nanofiber water dispersion of 0.1 wt % to less than 2 wt % (E-type or B-type clay-based), tensile strength, and a specific surface area of the porous film, the proportion of fibers having a diameter of less than 1 μm may be obtained. For example, reference may be made to WO 2013/054884.

<Water-Based Polymer for Binder>

In addition to cellulose nanofibers, the separator comprises a binder comprising or consisting of a water-soluble or water-dispersible polymer. The water-soluble or water-dispersible polymer is also referred to herein as a water-based polymer. The solubility of this polymer in water depends on temperature and concentration, but, for example, when polymer powder is added to water and stirred therein, the surface of the polymer powder is dissolved in water to be dispersed in water under conditions where the polymer powder is partially dissolved in water. By using such a polymer, adhesion between the porous film including a polyolefin-based resin and a cellulose nanofiber layer is enhanced.

The above-described water-based polymer may be a polymer having a reactive group capable of hydrogen bonding with cellulose nanofibers. The polymer having a reactive group capable of hydrogen bonding with cellulose nanofibers may be, for example, a polymer having a hydroxy group in a main chain thereof, a polymer having at least one selected from a hydroxy group, a functional group (—CO, —COO, —COOH, —CN, —NH₂, or the like) capable of hydrogen bonding with a CNF functional group in a side chain thereof, a polymer having a hydroxy group in a main chain thereof and having at least one selected from a hydroxy group, and a functional group (—CO, —COO, —COOH, —CN, —NH₂, or the like) capable of hydrogen bonding with a CNF functional group in a side chain thereof, or a combination thereof. As such, when the polymer having a reactive group capable of hydrogen bonding with cellulose nanofibers is used as a binder, hydrogen bonding between cellulose nanofibers may be suppressed to thereby manufacture a separator having excellent strength and excellent heat resistance.

Examples of the water-based polymer include urethane resin, acrylic resin, phenol resin, polyester resin, epoxy resin, polystyrene resin, polyvinyl alcohols, polyethylene resin, polyacrylamide resin, and modified products thereof. In this regard, polyvinyl alcohols are used in view of interlayer adhesion. The polyvinyl alcohols are not particularly limited in terms of the degree of polymerization, the degree of saponification, and the modifying group, but have a high degree of polymerization and a low degree of saponification to an extent that does not hinder the solubility thereof in water in terms of interlayer adhesion. In particular, the degree of polymerization is about 1,000 or more, and for example, ranges from about 1,000 to about 8,000, such as about 1,000 to 4,000, and the degree of saponification is about 90% or less, and, for example, ranges from about 60% to about 90%, for example, about 80% to about 90%, or about 85% to about 90%.

<Stacking of a First Layer as Porous Film and a Third Layer Including Cellulose Nanofibers>

In the present embodiment, a first layer including a polyolefin-based resin, which is a porous film, and a third layer including a water-soluble or water-dispersible polymer, which is a binder, and cellulose nanofibers are stacked, with a second layer formed by the interface of the first and third layers positioned therebetween, as further described below. A stacking method is not particularly limited, but, for example, stacking is performed using a method (coating method) of applying, to the porous film, a composition (water used as a solvent) including cellulose nanofibers and a binder consisting of a water-soluble or water-dispersible polymer, and then drying the resulting structure. This method is inexpensive and achieves high interlayer adhesion.

The composition may be, for example, in the form of a suspension.

When the stacking process is performed by coating, a small amount of suspension of the third layer is introduced into the pores of a portion of the first layer, resulting in formation of a second layer in which the polyolefin-based resin and the water-soluble or water-dispersible polymer binder coexist. The resulting second layer, therefore, comprises both a polyolefin resin (e.g., the same polyolefin resin of the first layer) and the water-soluble or water-dispersible polymer (e.g., the same water-soluble or water-dispersible polymer of the third layer). The second layer also is positioned between and in contact with both the first and third layers. The degree to which the binder is immersed in pores of the first layer may vary according to wettability of a coating composition and the molecular weight of the water-soluble or water-dispersible polymer used as a binder. In addition, the wettability of the coating composition may vary according to the amount of a water-soluble organic solvent included in the coating composition, the type of binder, the amount of binder, and the like. The water-soluble or water-dispersible polymer used as a binder has a weight average molecular weight of, for example, about 10,000 to about 500,000, for example, about 20,000 to about 300,000. When the weight average molecular weight of the water-soluble or water-dispersible polymer is within the above range, the thickness of the third layer may be, for example, about 1/10 or more the thickness of the first layer, for example, about 0.1× to about 5× the thickness of the first layer, or about 0.5× to about 2× the thickness of the first layer. As such, the third layer is partially introduced into the first layer to form a second layer therein, and thus the stacked layers are adhered to each other strongly and rigidly.

The thickness of the second layer will depend upon the degree to which the binder from the third layer penetrates the pores of the first layer, and may be, for example, about ½ (0.5) or less the thickness of the first layer, for example, about 1/100 to about ½, or about 0.02 to about 0.1, or about 0.04 to about 0.08 of the thickness of the first layer.

The total (combined) thickness of the second layer and the third layer is about 5 μm or less, and for example, ranges from about 0.5 μm to about 5 μm, for example, about 0.7 μm to about 4 μm, for example, about 1 μm to about 3 μm.

In some embodiments, water-based polymer used as a binder in the third layer does not include synthetic fibers (polyester fibers or the like) having a greater diameter than that of cellulose nanofibers, and thus in a lithium-ion secondary battery manufactured using the separator, transfer of lithium ions between electrodes is not hindered. As a result, good battery performance (cycle characteristics) may be realized.

A binder used in forming the third layer may have, for example, a non-fiber form, and thus may be introduced into pores of the first layer to thereby form the second layer.

When the thickness of the third layer including a binder and cellulose nanofibers is about 1/10 or more the thickness of the first layer, which is a porous film including a polyolefin-based resin, excellent strength characteristics are obtained without a reduction in heat resistance of the separator.

In addition, in the third layer, the amount of the water-based polymer used as a binder ranges from about 0.1 parts by weight to about 40 parts by weight , for example, about 0.5 parts by weight to about 30 parts by weight , for example, about 1 parts by weight to about 20 parts by weight , for example, about 1 parts by weight to about 10 parts by weight , per 100 parts by weight of the cellulose nanofibers. When the amount of the binder is within the above range, excellent heat resistance and excellent strength characteristics are obtained without concerns about breakdown of the separator due to insufficient mechanical strength (e.g., elongation at break or puncture strength) and a reduction in ionic conductivity due to clogging of pores of the separator. As used herein, elongation at break refers to a value measured in accordance with JIS K7127.

In addition, the amount of the cellulose nanofibers in the third layer ranges from about 60 parts by weight to about 99.9 parts by weight, for example, about 70 parts by weight to about 90 parts by weight per 100 parts by weight (total weight) of the water-based polymer and the cellulose nanofibers. When the amount of the cellulose nanofibers is within the above range, excellent heat resistance characteristics are obtained without a reduction in ionic conductivity of the separator and a reduction in mechanical strength (e.g., elongation at break) of the separator.

The amount of the water-based polymer in the second layer ranges from about 60 parts by weight to about 99.9 parts by weight, for example, about 70 parts by weight to about 90 parts by weight per 100 parts by weight (total weight) of the water-based polymer and the polyolefin-based resin.

In addition to coating the layers as described herein, the layers of the separator can be compressed optionally with heat, by which method the binder is further introduced into a portion of the pores the first layer, while contacting the third layer, to thereby form a second layer.

<Water-Soluble Organic Solvent>

The above-described third layer may be formed by applying cellulose nanofibers and the above-described suspension prepared by suspending the above-described binder and a water-soluble organic solvent in water to the above-described porous film including a polyolefin-based resin. The water-soluble organic solvent functions as a water-soluble pore-opening agent, and is removed by drying a coating solution, or the like, containing the solvent and thus a plurality of pore openings are formed in a film formed by drying the coating solution. The water-soluble organic solvent that acts as a water-soluble pore-opening agent may be an existing water-soluble organic solvent. For example, the water-soluble organic solvent may be at least one organic solvent selected from an alcohol-based organic solvent, a lactone-based organic solvent, a glycol-based organic solvent, a glycol ether-based organic solvent, glycerin, a carbonate-based organic solvent, and N-methylpyrrolidone. The alcohol-based organic solvent may be, for example, 1,5-pentanediol, 1-methylamino-2,3-propanediol, or the like. The lactone-based organic solvent may be, for example, ε-caprolactone, α-acetyl-γ-butyrolactone, or the like. Examples of the glycol-based organic solvent include, but are not limited to, diethylene glycol, 1,3-butylene glycol, and propylene glycol. Examples of the glycol ether-based organic solvent include, but are not limited to, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, and diethylene glycol diethyl ether. The carbonate-based organic solvent may be, for example, propylene carbonate, ethylene carbonate, or the like. A non-aqueous organic solvent may be, for example, glycerin, N-methylpyrrolidone, or a mixture thereof. According to one embodiment, triethylene glycol butyl methyl ether is used as the water-soluble organic solvent.

The water-soluble organic solvent may be removed in a drying process as described above, and may be removed in a washing process by an organic solvent. Thus, the water-soluble organic solvent is hardly present in a finally obtained non-aqueous secondary electrolyte separator.

<Separator for Non-aqueous Electrolyte Secondary Battery>

A separator for a non-aqueous electrolyte secondary battery, according to the present embodiment, includes a stacked film in which the first layer, the second layer, and the third layer are stacked. The separator may include other layers in addition to the stacked film. The separator has a thickness of about 5 μm to about 50 μm, for example, about 10 μm to about 45 μm,. When the thickness of the separator is within the above range, excellent heat resistance and excellent strength characteristics are obtained without a reduction in tensile strength of the separator and without concerns about insufficient battery capacity due to an excessively large proportion of the separator in a battery.

In addition, the separator of the present embodiment may have an air permeability of about 50 sec/100 cc to about 2,000 sec/100 cc, for example, about 20 sec/100 cc to about 1,000 sec/100 cc, for example, about 50 sec/100 cc to about 900 sec/100 cc, for example, about 100 sec/100 cc to about 800 sec/100 cc, for example, about 200 sec/100 cc to about 800 sec/100 cc, for example, about 300 sec/100 cc to about 600 sec/100 cc. When the air permeability of the separator is within the above range, the pore distribution of the separator is increased, such that the generation of inert lithium may be prevented, and the separator has high ionic conductivity.

In the present specification, air permeability refers to a value measured in accordance with J IS P8117.

<Method of Manufacturing Separator>

Hereinafter, a method of manufacturing a separator, according to an embodiment, will be described.

The method of manufacturing a separator includes: providing a porous film including a polyolefin-based resin; applying a composition obtained by mixing cellulose nanofibers, a binder, a water-soluble organic solvent, and water on the porous film; and drying a coating solution applied on the porous film.

The composition may be, for example, in the form of a suspension.

The drying process may be performed at a temperature of, for example, about 50° C. or more, for example about 60 to about 100° C. In addition, the method may further include, after the drying process, performing washing using an organic solvent. The organic solvent may be, for example, toluene or the like.

<Preparation Process>

The above-described porous film including a polyolefin-based resin is provided by any known technique or commercially available films. The thickness of the porous film may range from, for example, about 5 μm to about 45 μm. All other aspects of the polyolefin-based resin film is as previously described.

<Application Process>

First, an aqueous suspension of cellulose nanofibers, having a predetermined concentration, is prepared.

Subsequently, a water-based polymer for a binder as described herein is combined with the prepared aqueous suspension of cellulose nanofibers. All aspects of the cellulose nanofibers and water-based polymer are as previously described with respect to other aspects of the disclosure.

In some embodiments, the water-based polymer, which is a binder, is mixed in an amount of about 0.1 parts by weight to about 50 parts by weight, for example about 0.5 parts by weight to about 40 parts by weight per 100 parts by weight of the cellulose nanofibers.

In addition, the concentration of the cellulose nanofibers in the solution may be appropriately adjusted according to a film formation method. A solvent of the solution may be water, in view of handling and manufacturing costs, but a solvent having a higher steam pressure than water may be used instead.

Subsequently, a water-soluble organic solvent as described herein is added to the above-described suspension of cellulose nanofibers and water-based polymer. The amount of the water-soluble organic solvent added in the suspension may be adjusted according to characteristics of a desired film. By way of illustration, about 5 parts by weight or more, for example, from about 5 parts by weight to about 1,000 parts by weight, of the organic solvent per 100 parts by weight of the cellulose nanofibers is added to the suspension.

In addition, the order of addition of the binder and the water-soluble organic solvent may be opposite to what has been described above. That is, the water-soluble organic solvent may first be added to the aqueous suspension of cellulose nanofibers, and then the binder may be added thereto.

Subsequently, the prepared suspension is applied on the porous film. More particularly, the application process may be performed using any one method selected from a comma coater, a roll coater, a reverse roll coater, a direct gravure coater, a reverse gravure coater, an offset gravure coater, a roll kiss coater, a reverse kiss coater, a micro gravure coater, an air doctor coater, a knife coater, a bar coater, a wire bar coater, a die coater, a dip coater, a blade coater, a brush coater, a curtain coater, a die slot coater, a cast coater, and the like, or a combination of two or more of these methods. In addition, the application method may be of a batch type or a continuous type.

In addition, in consideration of adhesion of the suspension and the resulting dried coating film to the porous film, the porous film may be subjected to surface treatment such as fluorine coating, corona treatment, plasma treatment, UV treatment, anchor coating, or the like before or after applying the suspension to the porous film.

<Drying Process>

Subsequently, the composition applied onto the porous film is dried (solvent evaporated) to thereby form a second layer and a third layer. For example, the drying process may be performed by hot air drying, infrared light drying, hot plate drying, vacuum drying, or the like. The dried third layer may form a non-woven fabric including cellulose nanofibers as a main component.

In addition, the drying process may be performed, for example, at about 50° C. or more, for example, about 60° C. or more, with a view to sufficiently reducing the amounts of remaining water and organic solvent. In addition, the drying process may be performed at 130° C. or less, for example, about 110° C. or less, with a view to preventing the porous film from being degraded.

In addition, the obtained third layer (after drying) may be washed with an organic solvent or the like to remove additional remaining water-soluble organic solvent from the third layer. The organic solvent is not particularly limited, but for example, an organic solvent having a relatively high volatilization rate, such as toluene, acetone, methyl ethyl ketone, ethyl acetate, n-hexane, propanol, or the like, or a mixture of two or more of these organic solvents, may be used. Washing may be performed once or several times.

To wash the remaining water-soluble organic solvent, a solvent having high affinity with water, such as ethanol, methanol, or the like may be used. However, since the solvent can affect physical properties of the third layer (e.g., the sheet-like shape of the separator) due to absorption of moisture in air, water content of the solvent must be controlled and minimized. A solvent having high hydrophobicity, such as n-hexane, toluene, and the like, might be less effective at washing-outthe remaining water-soluble organic solvent, but such a solvent is less likely to absorb moisture, thus, the solvent may still be suitable for use in washing in order to remove the remaining water-soluble organic solvent.

For the above-described reasons, a solvent replacement method can be used that entails repeated (sequential) washing with increasingly hydrophobic solvents. For example, the washing process may be performed with acetone, toluene, and n-hexane in this order, or using other solvents with similarly increasing hydrophobicity.

Subsequently, the stacked film consisting of the first layer, the second layer, and the third layer can be pressed, optionally with heat, if desired. This press treatment is not necessarily required.

Hereinafter, a non-aqueous electrolyte secondary battery including the separator, according to an embodiment, and a method of manufacturing the same will be described.

The type of the non-aqueous electrolyte secondary battery is not particularly limited, and may be, for example, a jelly roll type, a stack type, a stack folding type, or a lamination-stack type.

The non-aqueous electrolyte secondary battery according to an embodiment is manufactured in a form in which an electrode assembly, including a positive electrode, a negative electrode, a separator as descried herein, and an electrolyte are included in a battery case. The electrode assembly has a structure in which the positive electrode, the negative electrode, and the separator described herein are wound together or stacked, with the separator positioned between the positive and negative electrodes.

The non-aqueous electrolyte secondary battery according to an embodiment may be, for example, a stacked battery. The non-aqueous electrolyte secondary battery may be a lithium secondary battery. The lithium secondary battery may be a lithium-ion battery, a lithium polymer battery, a lithium sulfur battery, a lithium air battery, or the like.

The negative electrode can be prepared according to a negative electrode fabrication method.

To fabricate a negative electrode, for example, a negative active material, a conductive agent, a binder, and a solvent may be mixed to prepare a negative active material composition, and directly coated on a current collector such as copper foil or the like to thereby fabricate a negative electrode plate. In another embodiment, the negative active material composition may be cast on a separate support and a negative active material film separated from the support may be laminated on a copper current collector to thereby fabricate a negative electrode plate. The negative electrode is not limited to the above-described type, and may be of other types.

The negative active material may be any negative active material that may be used as a negative active material of a lithium battery in the art. For example, the negative active material may include at least one selected from lithium metal, a metal alloyable with lithium, a transition metal oxide, a non-transition metal oxide, and a carbonaceous material.

The metal alloyable with lithium may, for example, be silicon (Si), tin (Sn), aluminum (Al), germanium (Ge), lead (Pb), bismuth (Bi), antimony (Sb), a Si-yttrium (Y) alloy (Y is an alkali metal, an alkali earth metal, a Group 13 to 16 element, a transition metal, a rare earth element, or a combination thereof except for Si), a Sn—Y alloy (Y is an alkali metal, an alkali earth metal, a Group 13 to 16 element, a transition metal, a rare earth element, or a combination thereof except for Sn), or the like. Examples of Y may include magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), and combinations thereof.

The transition metal oxide may be, for example, lithium titanium oxide, vanadium oxide, lithium vanadium oxide, or the like.

The non-transition metal oxide may be, for example, SnO₂, SiOx where 0<x<2, or the like.

The carbonaceous material may be crystalline carbon, amorphous carbon, or a mixture thereof. Examples of the crystalline carbon include natural graphite and artificial graphite, each of which has an irregular form or a plate, flake, spherical, or fibrous form. Examples of the amorphous carbon include, but are not limited to, soft carbon (low-temperature calcined carbon), hard carbon, mesophase pitch carbide, and calcined coke.

The conductive agent may be acetylene black, natural graphite, artificial graphite, carbon black, Ketjenblack, carbon fiber, metallic powder such as copper, nickel, aluminum, silver, or the like, metal fiber, or the like. In addition, conductive materials such as polyphenylene derivatives and the like may be used alone or a mixture of two or more of these materials may be used, but the present disclosure is not limited to the above-listed examples. That is, any conductive agent that may be used as a conductive agent in the art may be used. In addition, the above-described crystalline carbonaceous materials may be further used as a conductive agent.

Examples of the binder include a vinylidene fluoride/hexafluoropropylene copolymer, polyvinylidene fluoride (PVDF), polyacrylonitrile, polymethyl methacrylate, polytetrafluoroethylene, a mixture of the aforementioned polymers, and a styrene-butadiene rubber-based polymer. However, the binder is not particularly limited to the above examples and may be any binder that is commonly used in the art.

The solvent may be N-methylpyrrolidone, acetone, water, or the like. However, the solvent is not particularly limited to the above examples and may be any solvent that may be used in the art.

The amounts of the negative active material, the conductive agent, the binder, and the solvent may be the same levels as those generally used in a lithium battery. In some embodiments, at least one of the conductive agent and the solvent are not used.

A positive electrode can be prepared according to a positive electrode fabrication method.

The positive electrode may be fabricated in the same manner as in the negative electrode fabrication method, except that a positive active material is used instead of the negative active material. In addition, in a positive active material composition, a conductive agent, a binder, and a solvent may be the same as those used in the negative electrode.

For example, a positive active material composition may be prepared by mixing a positive active material, a conductive agent, a binder, and a solvent and may be directly coated on an aluminum current collector to thereby fabricate a positive electrode plate. In another embodiment, the positive active material composition may be cast on a separate support and a positive active material film separated from the support may be laminated on an aluminum current collector to thereby fabricate a positive electrode plate. The positive electrode is not limited to the above-described type, and may be of other types.

The positive active material may include at least one selected from lithium cobalt oxide, lithium nickel cobalt manganese oxide, lithium nickel cobalt aluminum oxide, lithium iron phosphate, and lithium manganese oxide. However, the positive active material is not limited to the above examples and any positive active material that may be used in the art may be used.

For example, the positive active material may be a compound represented by one of the following formulae: LiₐA_{1-b}B_{b}D₂ where 0.90≤a≤1.8 and 0≤b≤0.5; LiₐE_{1-b}bB_{b}O_{2-c}D_{c} where 0.90≤a≤1.8, 0≤b≤0.5, and 0≤c≤0.05; LiE_{2-b}B_{b}O_{4-c}D_{c} where 0≤b≤0.5 and 0≤c≤0.05; LiₐNi_{1-b-c}Co_{b}B_{c}D_{α} where 0.90≤a≤1.8, 0≤b≤0.5, 0≤c≤0.05, and 0<α≤2; LiₐNi_{1-b-c}Co_{b}B_{c}O_{2-α}F_{α where} 0.90≤a≤1.8, 0≤b≤0.5, 0≤c≤0.05, and 0<α<2; LiₐNi_{1-b-c}Co_{b}B_{c}O_{2-α}F₂ where 0.90≤a≤1.8, 0≤b≤0.5, 0≤c≤0.05, and 0<α<2; LiₐNi_{1-b-c}Mn_{b}B_{c}D_{α} where 0.90≤a≤1.8, 0≤b≤0.5, 0≤c≤0.05, and 0<α≤2; LiₐNi_{1-b-c}Mn_{b}B_{c}O_{2-α}F_{α} where 0.90≤a≤1.8, 0≤b≤0.5, 0≤c≤0.05, and 0<α<2; LiₐNi_{1-b-c}Mn_{b}B_{c}O_{2-α}F₂ where 0.90≤a≤1.8, 0≤b≤0.5, 0≤c≤0.05, and 0<α<2; LiₐNi_{b}E_{c}G_{d}O₂ where 0.90≤a≤1.8, 0≤b≤0.9, 0≤c≤0.5, and 0.001≤d≤0.1; LiₐNi_{b}Co_{c}Mn_{d}GₑO₂ where 0.90≤a≤1.8, 0≤b≤0.9, 0≤c≤0.5, 0≤d≤0.5, and 0.001≤e≤0.1; LiₐNiG_{b}O₂ where 0.90≤a≤1.8 and 0.001≤b≤0.1; LiₐCoG_{b}O₂ where 0.90≤a≤1.8 and 0.001≤b≤0.1; LiₐMnG_{b}O₂ where 0.90≤a≤1.8 and 0.001≤b≤0.1; LiₐMn₂G_{b}O₄ where 0.90≤a≤1.8 and 0.001≤b≤0.1; QO₂; QS₂; LiQS₂; V₂O₅; LiV₂O₅; LiIO₂; LiNiVO₄; Li_{(3-f)}(PO₄)₃ where 0≤f≤2; Li_{(3-f)}Fe₂(PO₄)₃ where 0≤f≤2; and LiFePO₄.

In the formulae above, A may be selected from nickel (Ni), cobalt (Co), manganese (Mn), and combinations thereof; B may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from oxygen (O), fluorine (F), sulfur (S), phosphorus (P), and combinations thereof; E may be selected from cobalt (Co), manganese (Mn), and combinations thereof; F may be selected from fluorine (F), sulfur (S), phosphorus (P), and combinations thereof; G may be selected from aluminum (Al), chromium (Cr), manganese (Mn), iron (Fe), magnesium (Mg), lanthanum (La), cerium (Ce), strontium (Sr), vanadium (V), and combinations thereof; Q is selected from titanium (Ti), molybdenum (Mo), manganese (Mn), and combinations thereof; I is selected from chromium (Cr), vanadium (V), iron (Fe), scandium (Sc), yttrium (Y), and combinations thereof; and J may be selected from vanadium (V), chromium (Cr), manganese (Mn), cobalt (Co), nickel (Ni), copper (Cu), and combinations thereof.

Also, the positive active material may have a coating layer on their surfaces, or may be mixed with a compound having a coating layer. The coating layer may include a coating element compound, such as an oxide or hydroxide of a coating element, an oxyhydroxide of a coating element, oxycarbonate of a coating element, or a hydroxycarbonate of a coating element. These compounds constituting the coating layers may be amorphous or crystalline. The coating element included in the coating layer may be Mg, Al, Co, potassium (K), sodium (Na), calcium (Ca), Si, Ti, V, Sn, germanium (Ge), gallium (Ga), boron (B), arsenic (As), zirconium (Zr), or a mixture thereof. A coating layer may be formed using the coating elements in the aforementioned compounds by using any one of various coating methods (e.g., spray coating or immersion) that do not adversely affect physical properties of the positive active material. This is well understood by those of ordinary skill in the art, and thus, a detailed description thereof will not be provided herein.

For example, the positive active material may be LiNiO₂,LiCoO₂, LiMnₓO₂x where x=1 or 2, LiNi₁₋ₓMnₓO₂ where 0<x<1, LiNi_{1-x-y}CoₓMn_{y}O₂ where 0≤x≤0.5 and 0≤y≤0.5, LiFePO₄, or the like.

The electrolyte used in the battery may be an organic electrolyte solution. In addition, the electrolyte may be in a solid phase. For example, the electrolyte may be boron oxide, lithium oxynitride, or the like, but is not limited to the above-listed examples, and any electrolyte that may be used as a solid electrolyte in the art may be used. The solid electrolyte may be formed on the negative electrode using a method such as sputtering or the like.

An organic electrolyte solution may be prepared by dissolving a lithium salt in an organic solvent.

The organic solvent may be any solvent that may be used as an organic solvent in the art. For example, the organic solvent may be propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, combinations thereof, or the like.

The lithium salt may be any material that may be used as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(CyF_{2y+1}SO₂) (wherein x and y are each independently a natural number), LiCl, LiI, combinations thereof, or the like.

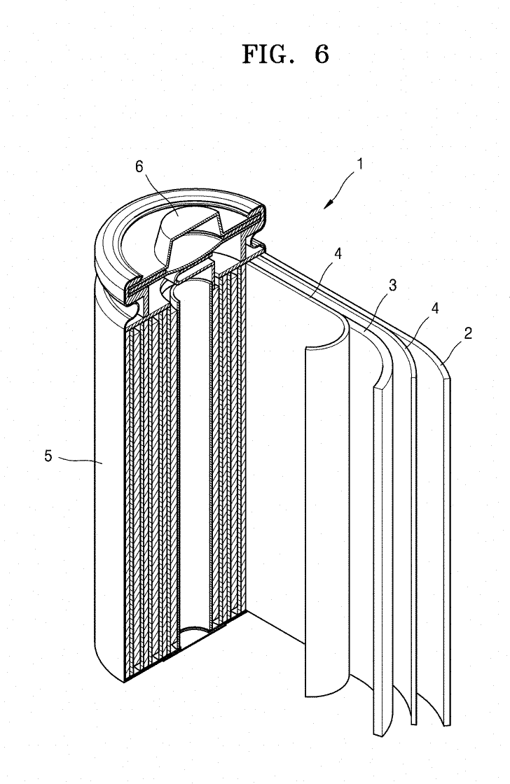

As illustrated in FIG. 6, a lithium battery 1 includes a positive electrode 3, a negative electrode 2, and a separator 4. The positive electrode 3, the negative electrode 2, and the separator 4 are wound or folded to be accommodated in a battery case 5. Subsequently, an organic electrolyte solution is injected into the battery case 5 and the battery case 5 is sealed with a cap assembly 6 to thereby complete the manufacture of the lithium battery 1. The battery case 5 may be a cylindrical type, a rectangular type, a pouch type, a coin type, or the like. The lithium battery 1 may be a thin-film type battery. The lithium battery 1 may be a lithium ion battery.

The non-aqueous electrolyte secondary battery may be classified into a variety of batteries such as a lithium air battery, a lithium oxide battery, an all-solid lithium battery, and the like.

In addition, a plurality of battery assemblies may be stacked to form a battery pack, which may be used in any device that requires high capacity and high output. For example, the battery pack may be used in a laptop computer, a smartphone, an electric vehicle, or the like.

In particular, the non-aqueous electrolyte secondary battery has excellent high-rate characteristics and lifespan characteristics, and is thus suitable for use in electric vehicles (EVs). For example, the non-aqueous electrolyte secondary battery is suitable for use in hybrid vehicles such as plug-in hybrid electric vehicles (PHEVs) and the like; E-bikes; E-scooters; electric golf carts; and systems for storing power.

Hereinafter, the present disclosure will be described in further detail with reference to the following examples. However, these Examples are provided for illustrative purposes only, and the scope of the embodiments is not intended to be limited by these Examples.

### EXAMPLE 1

Triethylene glycol butyl methyl ether as a water-soluble organic solvent (available from Toho Chemical Co., Ltd) was added to 0.5 wt % of an aqueous cellulose nanofiber suspension in a weight ratio of the suspension to the organic solvent of 100: 1 and stirred therein to thereby prepare a mixed solution. 0.5 wt % of the prepared aqueous solution of polyvinyl alcohol (degree of polymerization: 3,500, manufactured by Wako Pure Chemical Industries, Ltd.) was added to the mixed solution in an amount of 1 part by weight with respect to 100 parts by weight of the mixed solution and stirred therein to thereby prepare a suspension.

The obtained suspension was applied onto a polyethylene porous film (thickness: 7 μm, air permeability: 94 sec/100 cc) using an applicator such that a third layer obtained after drying had a thickness of 6 μm, followed by drying in an oven at 85° C. to remove water, sufficient washing with toluene, and drying again in an oven at 85° C., to thereby obtain separator 1. In separator 1, the thickness of a second layer including polyethylene and polyvinyl alcohol was about 500 nm.

Acetic acid bacteria-derived cellulose nanofibers having an average diameter of 50 nm, a diameter of 1 μm or more, a fiber content of 1%, and an average length of about 2.5 μm were used.

### EXAMPLE 2

Separator 2 was manufactured using the same materials and the same method as those used in Example 1, except that a suspension was coated such that the third layer obtained after drying had a thickness of 10 μm. In separator 2, the thickness of a second layer including polyethylene and polyvinyl alcohol was about 500 nm.

### EXAMPLE 3

Separator 3 was manufactured using the same materials and the same method as those used in Example 1, except that a suspension was coated such that a third layer obtained after drying had a thickness of 30 μm, and a coating film after drying was pressed at a pressure of about 50 MPa. After being pressed, the third layer had a thickness of 6 μm. In separator 3, the thickness of a second layer was about 500 nm.

### EXAMPLE 4

Separator 4 was manufactured using the same materials and the same method as those used in Example 1, except that a suspension was coated such that a third layer obtained after drying had a thickness of 45 μm, and a coating film after drying was pressed at a pressure of 50 MPa. After being pressed, the third layer had a thickness of 11 μm. In separator 4, the thickness of a second layer was about 500 nm.

### EXAMPLE 5

Separator 5 was manufactured using the same materials and the same method as those used in Example 1, except that a suspension was prepared by adding a maleic acid-modified polyethylene emulsion instead of polyvinyl alcohol to cellulose nanofibers in a weight ratio of the emulsion to the cellulose nanofibers of 100:20. In separator 5, the thickness of a second layer was about 500 nm.

### EXAMPLE 6

Separator was manufactured in the same manner as in Example 1, except that the amount of polyvinyl alcohol was changed to about 1 part by weight with respect to 100 parts by weight of the cellulose nanofibers.

### EXAMPLE 7

Separator was manufactured in the same manner as in Example 1, except that the amount of polyvinyl alcohol was changed to about 40 parts by weight with respect to 100 parts by weight of the cellulose nanofibers.

### COMPARATIVE EXAMPLE 1

Only the polyethylene porous film (first layer) used in Example 1 was used as separator 6.

### COMPARATIVE EXAMPLE 2

The polyethylene porous film (first layer) was not used, and a suspension was applied onto a PET film such that the thickness of a coating film after drying was 14 μm. The suspension was dried, the PET film was peeled off, and then the dried coating film was used as separator 7.

### COMPARATIVE EXAMPLE 3

A porous film, which was formed by applying alumina-based ceramic particles of a thickness of 4 μm onto a polyethylene porous film having a thickness of 14 μm, was used as separator 9.

### COMPARATIVE EXAMPLE 4

1 wt % of an aqueous solution of polyvinyl alcohol (a degree of polymerization: 3,500, manufactured by Wako Pure Chemical Industries, Ltd.) was applied onto the polyethylene porous film (first layer) used in Example 1 such that a coating film after drying had a thickness of 1 μm, followed by drying, and a third layer including cellulose nanofibers was formed on the coating film in the same manner as in Example 1. That is, the first layer did not directly contact the third layer, and a layer formed of polyvinyl alcohol was present therebetween.

### COMPARATIVE EXAMPLE 5

1 wt % of an aqueous solution of carboxymethylcellulose (MAC350HC, manufactured by Nippon Paper Chemical Co., Ltd.) was applied onto the polyethylene porous film (first layer) used in Example 1 such that a coating film after drying had a thickness of 1 μm, followed by drying, and a third layer including cellulose nanofibers was formed on the coating film in the same manner as in Example 1. That is, the first layer did not directly contact the third layer, and a layer formed of polyvinyl alcohol was present therebetween.

### EXAMPLE 13

Physical properties of the separators manufactured according to Examples 1 to 5 and Comparative Examples 1 to 5 were evaluated according to the following measurement method.

The thickness of each separator was measured using a micrometer.

The air permeability of each separator was measured using a Gurley type air gauge (Gurley type densometer, manufactured by TOYO SEIKI Co., Ltd.) specified in JIS8117, and the time taken for 100 cc of air to permeate was measured for a specimen closely fixed to a circular hole having an outer diameter of 28.6 mm. In addition, each separator was heated to 200° C. and measurement was performed before and after the heating.

To measure puncture strength, each separator was positioned and fixed between two sheets of metal plates with 1 uric') of pores perforated therethrough, and a needle probe having a tip of 1 mmφ (R=0.5) was used in a compression mode of a texture analyzer (manufactured by Eiko Seiki Co., Ltd.) at a test rate of 2 mm/sec. A point at which each separator was broken was determined as puncture strength.

The average pore diameter was measured by mercury porosimetry (Autopore IV9510, manufactured by Micromeritics).

Heat resistance was measured using a specimen having a width of 3 mm and a length of 30 mm (measurement portion: 20 mm, a TD direction is a major axis) fabricated from each separator. The temperature of the specimen was raised to 350° C. at a heating rate of 10° C./min, a thermomechanical analyzer (EXSTAR 6000, manufactured by Seiko Instruments Inc.) was used for measurement such that a force of 2 mN/μm per thickness acted on each specimen, and a point at which a displacement of 5% or more occurred was denoted as a heat resistance temperature.

Cycle characteristics were measured according to the following method. A test cell was manufactured using the fabricated separator. A positive electrode of the test cell was made of lithium nickel cobalt aluminum oxide (LiNo_{0.85}Co_{0.14}Al_{0.01}O₂), and a negative electrode thereof was made of artificial graphite. A stacked type battery was manufactured in a thermostat, an internal temperature of which was set at 25° C., and a formation operation was performed by performing charging and discharging (4.35 V to 2.75 V) at a rate of 10 hours. Subsequently, 1 cycle of constant-current and constant-voltage charging at a rate of 2 hours and constant-current discharging at a rate of 5 hours was performed, and initial capacity of the obtained value was checked. Thereafter, 200 cycles of charging and discharging (4.35 V to 2.8 V) were performed at a rate of 1 hour. 1 cycle of constant-current and constant-voltage charging at a rate of 2 hours and constant-current discharging at a rate of 5 hours was performed every 100 cycles at a rate of 1 hour, and a ratio of the obtained value with respect to initial capacity was denoted as capacity retention.

In addition, the measurement of cycle characteristics was performed on the test cells including the separators of Examples 1, 2, and 4 and Comparative Examples 1, 2, and 4.

The results of the above-described measurement of physical properties are shown in Table 1 below.

TABLE 1

| | | | | | | | | | Heat |
|---|---|---|---|---|---|---|---|---|---|
| | Thickness | | | | | Air permeability | | Puncture | resistance |
| | (μm) | | | | | (sec/100 cc) | | Strength | Temperature |
| | PE | CNF | total | Extra | CNF/PE | 1 | 2 | (gf) | (° C.) |
| Exam. 1 | 7 | 6 | 13 | 0 | 0.86 | 240.7 | ∞ | 322 | 321 |
| Exam. 2 | 7 | 10 | 17 | 0 | 1.42 | 277.2 | ∞ | 331 | 322 |
| Exam. 3 | 7 | 6 | 13 | 0 | 0.86 | 622 | ∞ | 335 | 325 |
| Exam. 4 | 7 | 11 | 18 | 0 | 1.57 | 922 | ∞ | 339 | 324 |
| Exam. 5 | — | — | — | — | — | 330.2 | ∞ | 330 | 320 |
| Comp. | 7 | 0 | 7 | 0 | 0 | 94 | Thermal | 340.1 | 143 |
| Exam. 1 | | | | | | | contraction | | |
| Comp. | 0 | 14 | 14 | 0 | — | 210 | 221 | 106 | 320 |
| Exam. 2 | | | | | | | | | |
| Comp. | 14 | 0 | 18 | 4 | 0 | 198 | Thermal | 350 | 165 |
| Exam. 3 | | | | | | | contraction | | |
| Comp. | 7 | 6 | 14 | 1 | 0.86 | ∞ | ∞ | 320 | 321 |
| Exam. 4 | | | | | | | | | |
| Comp. | 7 | 6 | 14 | 1 | 0.86 | ∞ | ∞ | 325 | 323 |
| Exam. 5 | | | | | | | | | |

In Table 1, 1 denotes before heating, 2 denotes after heating, PE denotes the thickness of a first layer, CNF denotes a total thickness of a second layer and a third layer, and a CNF/PE ratio denotes a thickness ratio of the third layer to the first layer.

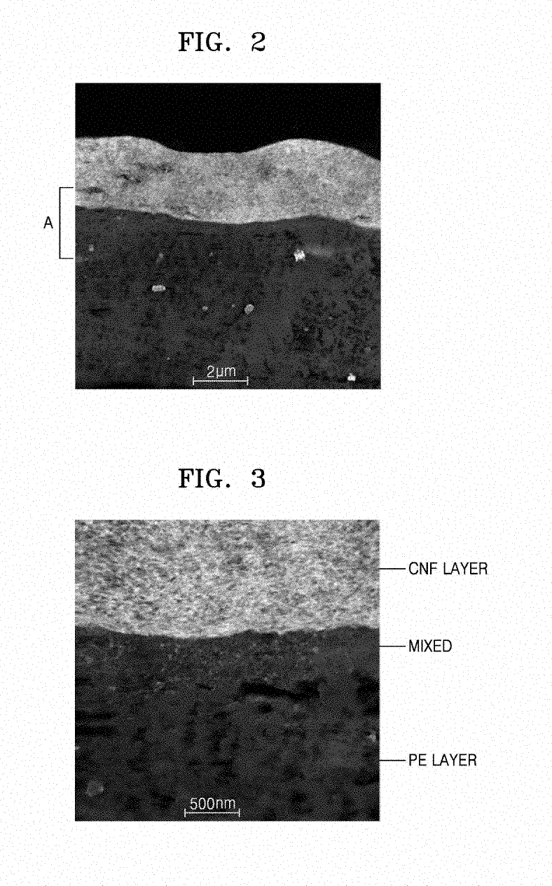

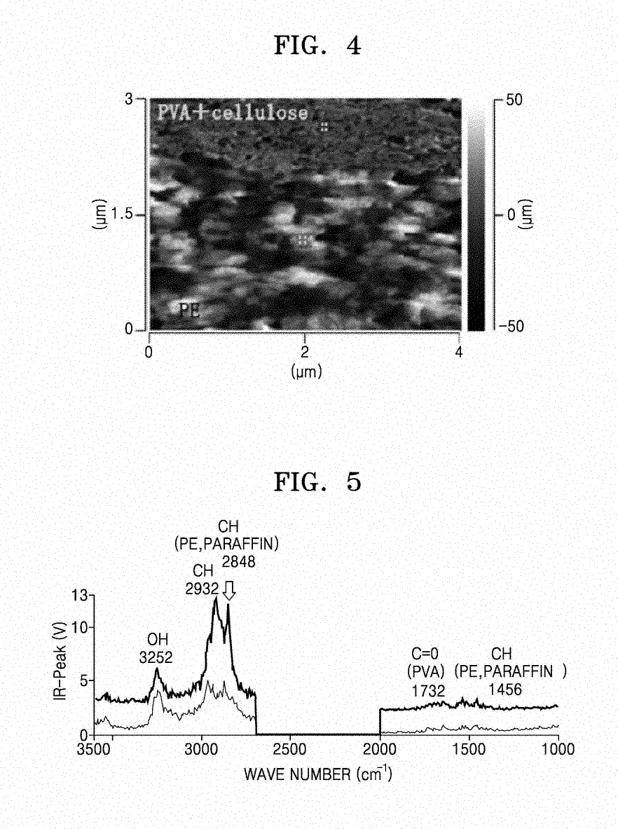

Microscope observation and NanolR spectrum observation were performed. Observation results are shown in FIGS. 2 to 5. FIGS. 2 and 3 provide a microscopic analysis obtained using Tecnai G2 F20 manufactured by FEI, wherein region A of FIG. 2 indicates the interfacial region between the first and third layer, including the second layer, and FIG. 3 is a higher magnification of region A of FIG. 2. FIG. 4 illustrates analysis results obtained using nano-IR2 manufactured by Anasys Instruments.

The results observed at upper observation points represented as four points illustrated in FIG. 4 are IR spectra on the upper side of FIG. 5, and the results observed at lower observation points illustrated in FIG. 4 are IR spectra on the lower side of FIG. 5. In the separators of Examples 1 to 5, polyvinyl alcohol or maleic acid-modified polyethylene was observed inside pores of polyethylene, on the side of a coated surface of each polyethylene porous film. In this embodiment, puncture strength was as high as 300 gf or more and a heat resistance temperature was 300° C. or higher, which indicates that each separator has a high puncture strength and a high heat resistance temperature (heat resistance). In addition, the separators of Examples 1 to 5 had both shutdown characteristics and a capacity retention greater than 90%. In addition, the capacity retention of each of the cases of Examples 3 and 5 was not measured.

Meanwhile, the separators of Examples 8 and 10 had puncture strength of as high as 300 gf or more, while having a heat resistance temperature of as low as 200° C. or less. The separator of Example 9 had a heat resistance temperature exceeding 300° C., while having a low puncture strength, i.e., 106 gf. In addition, the separators of Examples 11 and 12 had excessively high air permeability, and thus transfer of lithium ions was significantly hindered.

Physical properties of the separators fabricated according to Examples 6 and 7 were evaluated using the same measurement method as that used to evaluate the physical properties of the separators of Examples 1 to 5.

As a result of the evaluation, the physical properties of the separators of Examples 6 and 7 were at the same levels as those of the separator of Example 1.

The above-described examples are provided only for illustrative purposes and the present disclosure is not limited to these examples, and these examples may be combined or partially substituted with known techniques, tolerance techniques, and publicly known techniques. In addition, modified inventions readily obtained by those of ordinary skill are also within the scope of the present disclosure.

As is apparent from the foregoing description, according to an embodiment, a separator having excellent heat resistance, excellent mechanical strength, shutdown characteristics, and ease of handing, and a non-aqueous electrolyte secondary battery including the same and thus exhibiting enhanced cell performance can be provided.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

One or more embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A separator comprising:
a first layer comprising a polyolefin-based resin, wherein the first layer is a porous film;
a second layer comprising a polyolefin-based resin and a water-based polymer; and
a third layer comprising a water-based polymer and cellulose nanofibers.

2. The separator of claim 1, wherein about 80 wt. % or more of the cellulose nanofibers have a diameter of less than 1 μm.

3. The separator of claim 1, wherein the thickness of the third layer is about 1/10 or more that the thickness of the first layer.

4. The separator of claim 1, wherein the separator has a thickness of about 5 μm to about 50 μm.

5. The separator of claim 1, wherein the thickness of the second layer is about ½ or less the thickness of the first layer.

6. The separator of claim 1, wherein the polyolefin-based resin of the first layer and second layer comprises a polyethylene-based resin, a polypropylene-based resin, or a combination thereof.

7. The separator of claim 1, wherein the third layer comprises about 0.1 parts by weight to about 40 parts by weight water-based polymer per 100 parts by weight of the cellulose nanofibers.

8. The separator of claim 1, wherein the separator has an air permeability of about 50 seconds/100 cc to about 2,000 seconds/100 cc.

9. The separator of claim 1, wherein the third layer comprises about 60 parts by weight to about 99.9 parts by weight cellulose nanofibers per 100 parts by weight of the combined water-based polymer and cellulose nanofibers.

10. The separator of claim 1, wherein the second layer comprises about 60 parts by weight to about 99.9 parts by weight water-based polymer per 100 parts by weight of the combined polyolefin-based resin and water-based polymer.

11. The separator of claim 1, wherein the water-based polymer of the second layer and third layer is a polymer with a reactive group capable of forming hydrogen bonds with the cellulose nanofibers.

12. The separator of claim 1, wherein the water-based polymer of the second layer and third layer comprises a polymer having a hydroxy group in a main chain thereof, a polymer including at least one selected from a hydroxy group, —CO, —COO, —COOH, —CN, and —NH₂ in a side chain thereof, a polymer having a hydroxy group in a main chain thereof and having at least one selected from a hydroxy group, —CO, —COO, —COON, —CN, and —NH2 in a side chain thereof, or combinations thereof.

13. The separator of claim 1, wherein the water-based polymer of the second layer and third layer comprises at least one selected from: urethane resin, acrylic resin, phenol resin, polyester resin, epoxy resin, polystyrene resin, polyvinyl alcohol, polyethylene resin, polyacrylamide resin, and modified products thereof.

14. The separator of claim 1, wherein the water-based polymer of the second layer and third layer is non-fibrous.

15. A non-aqueous electrolyte secondary battery comprising: a positive electrode; a negative electrode; and the separator of claim 1 positioned between the positive electrode and the negative electrode.

16. A method of manufacturing a separator, the method comprising:
providing a porous film comprising a polyolefin-based resin;
applying a composition to the porous film, the composition comprising cellulose nanofibers, a water-based polymer, a water-soluble organic solvent, and water; and
drying the resulting product.

17. The method of claim 16, wherein the water-soluble organic solvent comprises at least one selected from an alcohol-based organic solvent, a lactone-based organic solvent, a glycol-based organic solvent, a glycol ether-based organic solvent, glycerin, propylene carbonate, and N-methylpyrrolidone, and
wherein the composition applied to the porous film comprises about 5 parts by weight or more of the water-soluble organic solvent per 100 parts by weight of the cellulose nanofibers.

18. The method of claim 16, wherein the water-soluble organic solvent comprises at least one selected from 1,5-pentanediol, 1-methylamino-2,3-propanediol, ε-caprolactone, α-acetyl-γ-butyrolactone, diethylene glycol, 1,3-butylene glycol, propylene glycol, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, glycerin, propylene carbonate, ethylene carbonate, and N-methylpyrrolidone.

19. The method of claim 16, wherein the water-based polymer is a polymer having a reactive group capable of forming hydrogen bonds with the cellulose nanofibers, and
the water-based polymer comprises at least one selected from a polymer having a hydroxy group in a main chain thereof, a polymer having at least one selected from a hydroxy group, —CO, —COO, —COON, —CN, and —NH₂ in a side chain thereof, and combinations thereof.

20. The method of claim 16, wherein the water-based polymer comprises at least one selected from urethane resin, acrylic resin, phenol resin, polyester resin, epoxy resin, polystyrene resin, polyvinyl alcohol, polyethylene resin, polyacrylamide resin, and modified products thereof, and
wherein the composition applied to the porous film comprises about 0.1 parts by weight to about 50 parts by weight of the water based polymer per 100 parts by weight of the cellulose nanofibers.

21. The method of claim 16, wherein the drying is performed at a temperature of about 50° C. or more.

22. The method of claim 16, further comprising, after drying, washing the dried composition with an organic solvent.

23. The method of claim 16, wherein about 80 wt. % of the cellulose nanofibers have a diameter of less than 1 μm.

24. The method of claim 16, wherein the polyolefin-based resin comprises a polyethylene-based resin, a polypropylene-based resin, or a combination thereof.
